(19) United States
(12) Patent Application Publication
(10) Pub. No.: US 2022/0261936 A1
(43) Pub. Date: Aug. 18, 2022

(54) Social Learning Platform, Apparatus, Systems and Methods

(71) Applicant: Unite Humanity, LLC, Austin, TX (US)

(72) Inventor: Bryan J. Kosarek, Austin, TX (US)

(21) Appl. No.: 17/672,523

(22) Filed: Feb. 15, 2022

Related U.S. Application Data
(60) Provisional application No. 63/285,735, filed on Dec. 3, 2021.
(60) Provisional application No. 63/245,089, filed on Sep. 16, 2021.
(60) Provisional application No. 63/149,620, filed on Feb. 15, 2021.

(51) Int. Cl. G06Q 50/20; G09B 5/14; G06Q 50/00

(52) U.S. Cl. CPC G06Q 50/20; G06Q 50/01; G09B 5/14

(57) ABSTRACT

Various methods, apparatus, and systems for connecting parties via a network-based platform based on mutual interests and/or facilitating the provision of support to others to achieve a desired outcome or goal by way of the platform are disclosed. In one form, a system is provided having a processor-based platform configured to: receive personal information and one or more topics of interest associated with a user; receive a selection from the user to create at least one of an instructor user profile or a learner user profile; receive learning content from one or more instructors; determine via predictive analytics, at least a subset of learning content to provide to the user based at least in part on the personal information and one or more topics of interest; and present the at least a subset of learning content to the user via a user device associated with the user.

### CROSS-REFERENCE TO RELATED APPLICATIONS

This application claims the benefit of U.S. Provisional Application No. 63/285,735, filed Dec. 3, 2021, U.S. Provisional Application No. 63/245,089, filed Sep. 16, 2021, and U.S. Provisional Application No. 63/149,620, filed February 15, 2021, all of which are hereby incorporated herein by reference in their entireties.

### FIELD

The invention relates to various methods, apparatus, and systems for connecting parties via a network-based platform based on mutual interests and/or facilitating the provision of support to others to achieve a desired outcome or goal by way of the platform.

### BACKGROUND

Currently, those seeking advice and support regarding personal growth, for example, how to handle a problem in their life or to achieve a goal, are left with few options. One option is to seek out a peer who is able to offer advice or guidance on a certain situation. However, many do not directly know anybody to approach to get reliable advice regarding how to handle a problem or achieve a specific goal. Individuals may turn to the internet for articles and blogs written on their given topic. However, sifting through pages of unfamiliar educational content is often overwhelming and undesirable to those desiring to self-learn and do so in an efficient manner.

Another option is to seek professional help. For example, one seeking advice regarding a problem or a life goal may pay a counselor, a life coach, a psychologist, therapist, consultant, or some other expert in a relevant field for counseling and advice. Seeking professional help, however, is often expensive, time consuming and may be unnecessary given one's problem or goal. Moreover, identifying a professional that is able to best provide for their needs is difficult given the lack of visibility into the professional's focus and specialty. The inability to sample works from the service provider beforehand can also make for an inefficient process and/or fail to produce the desired content or results. As a result, individuals often forego a visit to a professional and continue to struggle on their own.

### BRIEF DESCRIPTION OF THE DRAWINGS

FIG. 1 is a schematic diagram of an interactive social learning environment system including a social learning platform in accordance with one embodiment of the invention.

FIG. 2 is a block diagram of a user device used to access the social learning platform of FIG. 1.

FIG. 3 is a block diagram of various features of the social learning platform of FIG. 1.

FIGS. 4A-E show screenshots of an example graphical user interface of a home screen of the social learning platform of FIG. 1.

FIGS. 5A-E show screenshots of an example graphical user interface of a discovery tool of the social learning platform of FIG. 1.

FIG. 6 shows a screenshot of an example graphical user interface of a livestream page of the social learning platform of FIG. 1.

FIG. 7A shows a screenshot of an example graphical user interface of a spark card page of the social learning platform of FIG. 1.

FIG. 7B shows a screenshot of a spark card of the social learning platform of FIG. 1.

FIGS. 8A-B show screenshots of an inbox feature of the social learning platform of FIG. 1.

FIG. 9 shows a screenshot of a goal board of the social learning platform of FIG. 1.

FIG. 10 shows a screenshot of an inner circle page of the social learning platform of FIG. 1.

FIG. 11 shows a screenshot sessions page of the social learning platform of FIG. 1.

FIG. 12 shows a screenshot of a sign-up page of the social learning platform of FIG. 1.

FIG. 13 shows a screenshot of a connect page of the social learning platform of FIG. 1.

FIG. 14 shows a screenshot of an example graphical user interface of a live conversations feature of the social learning platform of FIG. 1.

FIG. 15A-D shows screenshots of example graphical user interfaces for adding and interacting with content via the spark feature of the social learning platform of FIG. 1.

FIGS. 16A-B show screenshots of example graphical user interfaces illustrating user interaction with content of the social learning platform of FIG. 1.

FIG. 17 illustrates an example graphical user interface for an audio player feature that may be collapsed to allow the user to explore while listening to content of the social learning platform of FIG. 1.

FIG. 18 shows example screenshots of a transcript feature enabling a user to view a transcript of audio content of the social learning platform of FIG. 1.

FIG. 19 shows a screenshot of an example graphical user interface providing the user with options for interacting with content of the social learning platform of FIG. 1.

FIGS. 20A-B show screenshots of example graphical user interfaces for purchasing coins of the social learning platform of FIG. 1 to access additional content of the social learning platform of FIG. 1.

### DETAILED DESCRIPTION

In one form, a platform for interactive learning in a social environment is provided herein. The platform may be accessible by multiple users via a network (e.g., such as a wide area network (WAN) like the internet, a local area network (LAN), a limited access network like a subscription service, etc. Some users may join as mentors or instructors and provide content for other users who join as learners. The mentors may provide content such as hosting live or recorded classes, lessons, lectures, or other interactive teaching sessions, hosting live discussions, one-on-one conversations with learners, hosting question and answer sessions, writing blog posts or other articles, and otherwise providing informative content for use by learners. The terms mentor and instructor are used interchangeably herein, but it should be understood that mentors/instructors may also in turn be learners at times and vice versa.

Learners may join the platform and browse or select topics of interest that they would like to learn more about. The learners may subscribe to or follow one or more mentors to receive some or all of the content posted or uploaded by the mentor(s). The learners may tune in to live sessions hosted by the mentors, ask mentors questions via a live audio or video chat, a forum, or a question-and-answer board. The learners may also view and read the blog posts and articles posted or uploaded by the mentors. In some forms, a user has a home page that displays content recently posted or uploaded by the mentors the learner follows or subscribes to. In other forms, the learner gets an alert when a mentor uploads new content that the learner has subscribed to. Leaners may also connect with other learners seeking similar support to share helpful resources and support each other on their personal journey toward a goal. Learners can also be mentors at times and vice versa.

In a preferred form, this platform is a social broadcasting platform that will deliver live, interactive content at the intersection of self-help, social learning, and entertainment. The platform may be provided on a mobile app and/or website to those specifically seeking/offering personal development training and interactive learning support.

Using the social interactive learning platform provided herein, learners can seek the help and guidance they desire for personal growth by interacting with mentors and content on the platform that is relevant to the area of personal growth desired by a particular learner. Mentors or instructors may produce, upload, or otherwise provide interactive content on topics they are knowledgeable of for learners to use for personal growth and learning. instructors may even host live workshops, classes, or collaboration sessions where learners and mentor(s) physically gather to learn and grow together in person. Mentors or instructors may also use the platform as learners in topic areas they desire to grow or learn.

Although the terms instructor or mentor and learner have been used in the main examples discussed herein, it should be understood that other titles could apply and these headings are intended to capture a variety of people with a variety of different goals in mind. For example, the instant disclosure has the potential to become an aggregator for the well-being, personal development and mental health industries including, but not limited to, life coaches, personal and professional coaches, speakers, psychologists, therapists, healers, educational institutions, non-profits and even activists, athletes, creatives, corporations, spiritual guides, consultants, and/or counselors. Anyone who is looking to monetize their knowledge within the well-being, personal development, self-help, or mental health industries has the potential to become a instructor to guide learners and pay a subscription. Instructors may pay a subscription fee to list, publish, post, and make their learning content and advice available on the platform. Learners may also pay a subscription fee or additional fees to unlock content within the platform that requires a higher tier subscription (e.g., offering a public portion of the service and a subscriber or private portion with additional content, etc.). Instructors and learners may join the platform for free, with a more limited scope of features available to them.

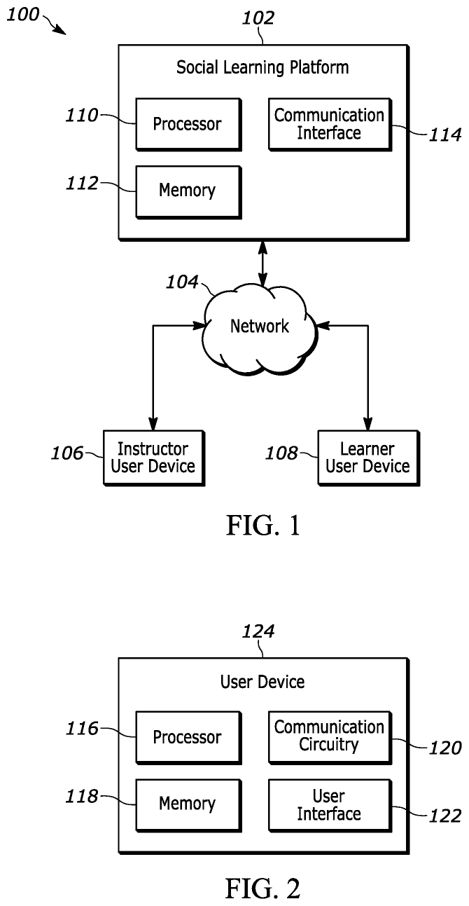

With respect to FIG. 1, an interactive social learning environment system 100 is shown according to one embodiment. The interactive social learning environment system 100 includes a social learning platform 102, a network 104, at least one instructor user device 106, and at least one learner user device 108. The social learning platform 102 includes a processor 110, a memory 112, and a communication interface 114. The processor 110 is in communication with the memory 112 and the communication interface 114 and configured to carry out various aspects of the social learning platform 102, described in further detail below. The processor 110 may include the processors 110 of one or more computing devices, such as, for example, server computers. The memory 112 stores executable instructions for the processor 110 to execute to carry out the functionality of the social learning platform 102. The memory 112 may further include a database of user accounts and information associated with the user accounts, for example, information and data about the learners and instructors and their activity. The memory 112 may also store learning content provided by the instructors and accessible by the learners. The memory 112 may be comprised of multiple memories accessible by the processor 110. The memories may be located in separate physical locations and accessible by the processor 110 via the network 104 or, alternatively, onboard a device if desired (e.g., a thin client software arrangement or setup vs. a thick client software arrangement or setup).

The communication interface 114 enables the processor 110 to communicate via the network 104. The processor 110 may communicate with the instructor user devices 106 and the learner user devices 108 over the network 104 using the communication interface 114. The network 104 may be a communication network including, as an example, the internet which may be accessible via a wireless network connection, a wired network connection and/or a cellular network connection.

With respect to FIG. 2, a user device 124 is provided, that may serve as the instructor learning device 108 and/or the learner user device 110 when the user is signed into the platform 102. The user device 124 may be any user device including a smartphone, personal digital assistant, computer tablet, personal computer, television, wearable computer (e.g., smartwatch, or smartglasses), smartspeaker or other Internet of Things (IoT) enabled device, etc. The user device 124 may include a processor 116, memory 118, communication circuitry 120, and a user interface 122. The processor 116 is in communication with the memory 118, communication circuitry, and the user interface 122. The memory 118 may store information and instructions pertaining to a mobile application of the social learning platform 102. The processor 116 may access the memory 118 to execute instructions to carry out the functionality of the application. In other forms, the user device 124 does not include an application but accesses the social learning platform 102 via the internet, for example, via a website associated with the social learning platform 102. The processor 116 communicates with the social learning platform 116 via the network 104. The processor 116 may communicate via the network 104 using the communication circuitry 120. The communication circuitry 120 may permit the user device 124 to communicate via one or more wired or wireless protocols, for example, the Wi-Fi, cellular, ethernet, and the like. The communication circuitry 120 enables the user device 124 to transmit and receive information from the social learning platform 102 via the network 104.

The user interface 122 of the user device 124 enables a user to input and receive information through the user device 124. The user interface 122 may include a display screen, a touchscreen, a microphone, a speaker, a camera, or one or more physical input items (e.g., buttons, switches, joysticks, wands, fobs, controllers, and/or a mouse as examples).

In a preferred form, users of the platform 102 create a user account via a smartphone application or a website associated with the platform 102 using a user device 124. Users may create login credentials (e.g., a username and password) that the user may use to access the platform 102. Users desiring to learn or to receive content may user access the platform 102 via the user device 124 and input information via the user interface 122 to set up a learner user account. Similarly, instructors desiring to teach or provide learning content and advice to others may access the platform 102 via the user device 124 and input information via the user interface 122 to setup an instructor user account. The instructor may also select to be a learner and be both an instructor and a learner.

When a learner signs up for an account, the platform 102 (via the website or user device application) presents the user with a series of questions via the user interface 122 to collect data about the user based on the user's responses. The user data may be used in determining which content to promote to the user based on what the platform 102 determines may be of interest to the user. For example, the platform 102 may ask how the user found the platform 102, whether people turn to them for advice, why they came to the platform 102, areas where the user is interested in support, and what activities are of interest to the user. Example areas of support may include health, wealth, and relationships. The platform 102 may present a plurality of selectable options that the user may select in response to each question presented. The user may input their response via the user interface 122. The user device 124 may communicate the response to the platform 102 for processing and/or storage. Based on the user's responses, the platform 102 may adjust or present different questions to the user to collect further information about the user and their interests or preferences.

The platform 102 may also ask the user for personal information. For example, the platform may ask the user for their gender, birthday, orientation, race, relationship status, whether they consider themselves to be religious and/or spiritual. The platform 102 may further ask questions regarding how the user likes to learn and how much time the users spends on personal development. The platform 102 may receive the user's response to each question presented and store the user's selection in memory 112. The platform 102 uses the provided information to determine how the user could connect with and support other uses of the platform, including instructors and other learners. Collecting and evaluating the learner's interests, desires, and time availability received when a user is setting up an account is the initial data used in building the user's profile and serves as the foundation for how learners are matched with instructors or mentors.

When an instructor or mentor signs up for an account, the platform 102 may present the user with other questions to determine the instructor's credentials, experience level, and areas they would like to mentor and instruct others in. For example, the platform 102 may ask the user what their level of experience is, why they joined the platform 102, what topics or areas they can support others in, their interests, and how much time they have to devote to learners they support. The platform 102 may also ask a series of questions to gather personal information about the instructors such as their gender, birthday, orientation, race, relationship status, whether they consider themselves to be religious and/or spiritual. The platform 102 uses the provided information to determine how the instructor could connect with and support learners and other instructors. Evaluating the instructor's interests, desires, and time availability received when a user is setting up an account is the initial data used in building the user profile and serves as the foundation for how the instructor is matched and with other learners. For example, when the platform 102 determines an instructor has a teaching style a learner would enjoy along with several of the same interests or passions, the platform 102 may suggest the learner subscribe the instructor or otherwise connect the two users.

Instructors may then use the application or website of the platform 102 to provide or upload learning content to the platform 102 for use and viewing by others. As examples, the instructor may provide learning content relating to health, wealth, relationships, clarity, direction, core strength development, focus and mindset, skill acquisition (e.g., photography, web development, etc.), time management, goal acceleration and attainment, life balance, life purpose, religion and spirituality (e.g., angels, astrology, Hinduism, prayer, etc.), therapy (e.g., acupuncture, aromatherapy, alternative medicine, etc.), mystery (e.g., Area 51, Atlantis, crop circle, alien abduction, etc.), diet (e.g., veganism, vegetarianism), and any other topics others may be interested in learning about, discussing, etc.. Instructors may schedule and/or host a livestream seminar where learners and the instructor join a live session to discuss and collaborate about a certain topic. The livestream seminar may be a video and/or audio stream where the instructor gives a presentation and/or facilitates discussion among learners who have joined the session. The instructor may similarly upload a recorded seminar, session, or podcast for learners to view and learn from in the future. The instructor may host a virtual workshop via the platform 102 where learners join, and the instructor teaches and instructs learners regarding a topic. The instructor may similarly schedule and host a group discussion on a topic, engage in a one-on-one discussion with a learner, and mentor one or more learners via the platform 102. The instructor may create a training program comprising a series of modules for learners to interact with to learn about a topic. The instructor may also create and upload self-directed learning materials including articles, blogs, links to other sources and insights, etc. The instructor may post or upload insights including links to articles and other resources (e.g., of other mentors on the platform 102, YouTube videos) that may be of interest to learners that subscribe to them. Content posted or uploaded by an instructor may be broadcast to their subscribers so that subscribers are made aware of the new content or insights. The instructor may also schedule learning sessions at a physical location where the instructor and learners physically meet rather than a virtual session via the platform 102.

The instructor may use the user device 124 to record and provide interactive learning content to the learners. For example, the instructor may use a camera and microphone of the user device 124 to record or live broadcast a training session. The instructor may also use the user device 124 to upload content and schedule meeting sessions with learners.

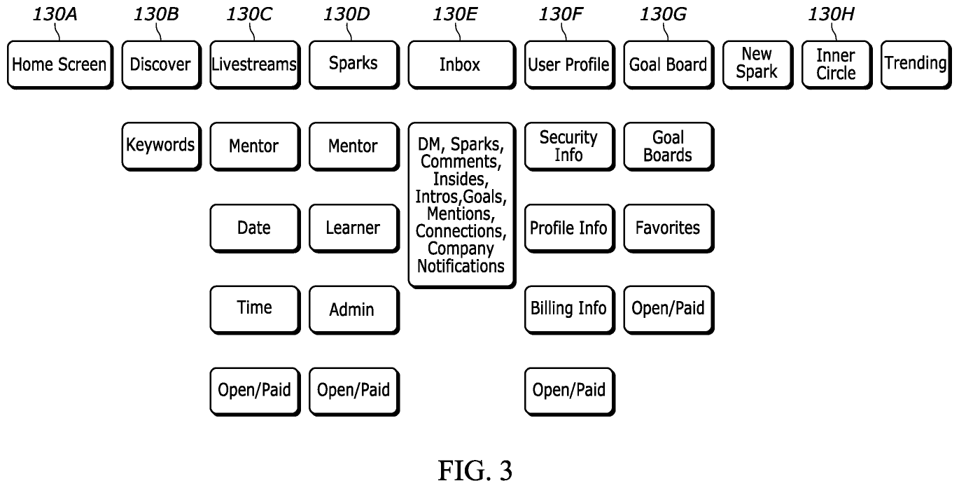

Once the learner has created a user account, the learner is able to access the content provided by the instructors. With reference to FIG. 3, the mobile application or website provides the learners with a plurality of tabs the user is able to select to access and/or use features 130 of the platform 102 include a home screen 130A, discover tool 130B, livestream tab 130C, sparks tab 130D, inbox 130E, user profile 130F, goal boards 130G, inner circle page 130H.

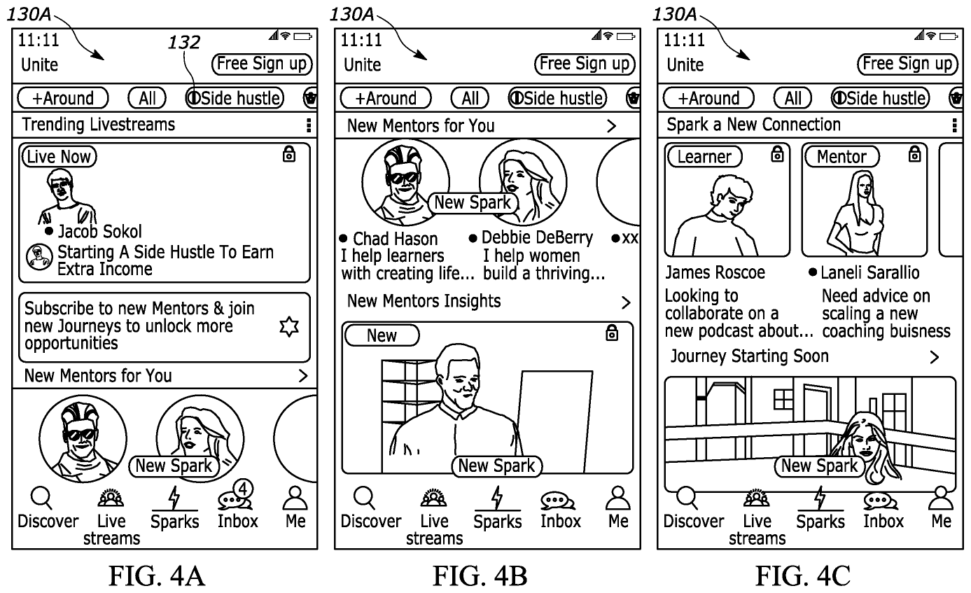

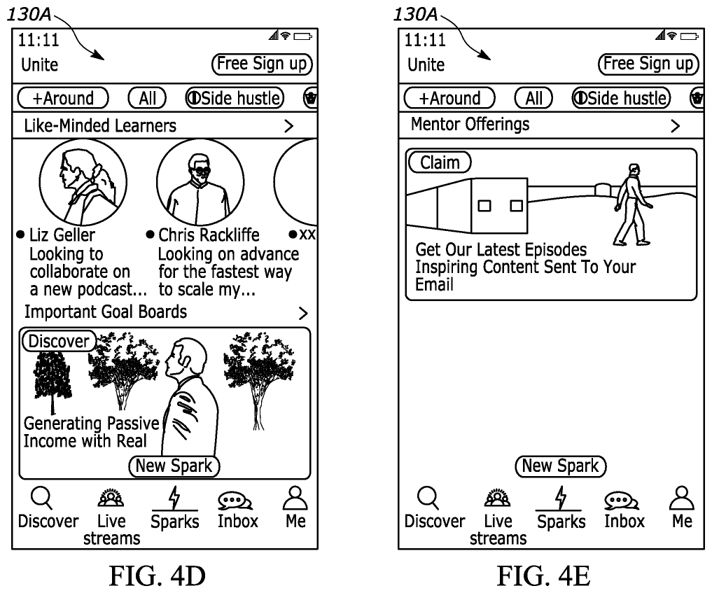

The platform 102 may provide users (e.g., learners and instructors) with a home screen 130A that lists suggested content for the user to view, instructors for the users to subscribe to, or other users to connect with. The user may select to view content the platform 102 promotes to the user. In some embodiments, and with respect to FIGS. 4A-E, the platform 102 presents a scrolling carousel bar menu 132 at the top of the home screen 130A. A user may select (e.g., touch with their finger or stylus, click with a mouse, etc.) the carousel menu and slide it to the left or the right to scroll through the items on the menu. This scrolling bar menu 132 allows users to add journeys they are interested in joining to receive support around and/or offer support. When a learner joins the platform 102, they can choose from a list of available journeys and add them to their menu bar to curate the content displayed on their home screen 130A. By allowing users to curate the content added and seen on their home screen 130A, learners are able to quickly, and easily identify the helpful and relevant instructors, peers, insights, and resources for them on their personal journey, without having to sift through millions of results as when searching on the internet, for example. Moreover, as the user curates the content, the platform 102 collects data regarding content and peers the user is interested in, allowing the platform 102 to provide relevant fresh content to the user as it becomes available on the platform 102.

When a user selects to join a journey program via their user device 124, their selection is communicated to the platform 102. Based on the selection to join a journey program, the platform 102 presents curated content to the learner via the user device 124 based at least in part on the selected journey program. This curated content associated with the learner's selected journey program(s) may be presented to the learner on their home screen 130A. Thus, the content on the home screen 130A will change and adapt based on user's signals and activity which will include in-session behavior, user data, and user characteristics. In-session behavior will also influence the home screen 130A content based on which pages they visit, which products or subscriptions they purchase, and how long they spend on a site.

The content presented on the home screen 130A may vary based on whether the user is an instructor, a learner, or both. Both learners and instructors may be presented with trending livestreams, insights, learning resources, spark cards 138 and the like on their home screen 130A. The platform 102 may also present learners and instructors with a suggestion to spark a new connection, journeys that are starting soon, inner circle or connected user's interests, important goal boards, instructor or mentor offerings to subscribe to, and drop-in sessions that are available for the learner or instructor to join and participate in.

Learners may further be presented with a list or profile of mentors the platform 102 determines the users should know or new mentors to consider subscribing to. Learners will be presented with the insights of mentors and instructors they subscribe to. Learners may select these insights to learn from the insight content the instructor has provided. Learners may also be presented with one or more profiles or lists of other learners the platform 102 has determined are similar to or like-minded to the learner.

Instructors may further be presented with new learners the platform 102 determines could be a user the instructor may connect with well and be able to help and support. The instructor may opt to connect with the learner, chat (e.g., video, audio, or text messaging) with them, and/or suggest they join a learning session of the instructor or view the instructors learning content or programs. The platform 102 may also present instructors with topics to unite around on their home screen 130A.

The platform 102 may determine which instructors or mentors may be of interest to the learner and which learners will connect well with a particular instructor. The platform 102 may determine to present instructors to learners based on the topics they speak, teach, and/or are knowledgeable about and the learner's determined interests and areas they indicated they would like support in. The platform 102 may further present other content to the learner that the platform 102 determines the user may find of interest such as articles, a journey to take, blog posts, videos, photos, testimonials, upcoming livestreams, a topic to explore, an insight, podcasts, other learners with similar interests, other learners seeking to learn about or grow in similar areas to connect with, goals the learner may select to seek to accomplish and a suggested learning session.

The platform 102 may monitor a user's activity on the platform 102 to determine additional content the user may be interested in. For example, the platform 102 may monitor which topics a learner searches for, which pages a learner views, how long they view a particular page, image, or video, what percentage of an article the user read, who the user interacts with or connects with, etc. Based on the learner's selected interests, areas they would like support in, personal information, subscriptions, and activity in the platform 102, the platform 102 may provide dynamic content to the learner based on their preferences. To do this, the platform 102 may determine a subset of learning content to provide to the user based on the learner's activity and other information associated with the learner's account. The platform 102 may determine content the user was interested in and/or enjoyed and use predictive analytics to determine additional or new content to provide to the user. For instance, the platform 102 may use predictive analytics to determine content that is similar to content the user has previously been interested in and/or enjoyed. As new content becomes available, the platform 102 may identify the content as of interest to a user based on their previous activity and interest and present the identified subset of learning content to the learner. Identified new or additional content a user may be provided or presented to the user via the home screen 130A or a link sent to the user's inbox 130E for example.

In some forms, the platform 102 may be configured to have the learner tag content or instructors the user finds of interest during the regular use of the platform 102. For example, the user may rate or review a particular learning session or instructor. As another example, a user may favorite, save, or share content. In some forms, the platform 1012 uses artificial intelligence (“Al”) and/or machine learning datasets to match learners and instructors with one another and with content that may be of interest to the user. For example, all of the user selections and feedback (e.g., likes, favorites, shares, repeated content in a particular area, etc.) may be used to determine via AI other content that may be suitable or desirable to the user and present same to the user automatically to assist in making the systems, methods and apparatus disclosed herein more helpful, entertaining and/or enjoyable. In some forms, additional support matching features will be added (using predictive analytics) as well. In one form, an initial data set will be developed for early-stage features and trained to the AI function of the platform 102. From there, the AI will continue to learn and build on the initial datasets by collecting data and continuing to build more refined datasets from that data.

Based on activities of the learner indicating whether the learner liked or disliked particular content and other monitored user activity, the platform 102 may create a dataset indicative of content and instructors the user likes and dislikes. The platform 102 may compare new content to this dataset for each users to determine whether a user would like the new content. If it is determined that the learner would like the new content, the content is promoted or presented to the user. For example, the content may be presented to the user via the home screen 130A of the application. As another example, the content is pushed to the user device 124 via a push notification or sent to the inbox 130E. As yet another example, the platform 102 sends an email to an email address associated with the user account of the learner including a link to access the content.

The platform 102 may further include a personal development chatbot that learners can message or talk with. For example, the chatbot may be a messaging system that a learner texts with. As another example, the chatbot may speak with a learner via a microphone and speaker of the learner's user device. For instance, a learner may speak a question or response into the microphone of the user device and the chatbot may provide a response played audibly through the speakers of the user device. The learner may select to start a conversation with the chatbot to ask questions about the platform 102 and/or about certain topics the learner would like more information about. For example, a learner may ask the chatbot for insights, content, classes, recommended mentors, etc. pertaining to a certain topic. The chatbot may be configured to ask the learner questions to learn about the learner. As a learner talks with the chatbot, the platform 102 collects data from the learner based on the conversations with the chatbot. The platform 102 uses predictive analytics to determine insights, information, or content that is likely to be useful to the learner based on the learner's conversations with the chatbot. The chatbot uses artificial intelligence technology to learn and study a learner through conversations with the learner to identify trauma, emotional blocks, or patterns in the learner's life that may be holding the learner from growing or moving forward. The chatbot may suggest and provide the learner with suggestions, content, insights, and other options to read, view, or explore based on the conversation with the chatbot. The chatbot may further introduce the learner to mentors that may be a good fit for the learner based on the guidance the learner is seeking and the identified personality or learning styles of the learner. The chatbot thus draws out information from the learner through a conversation and suggests and provides a learner with content, classes, workshops, etc. on the platform 102 to help that learner grow on their personal journey. The information learned about a learner through a chatbot conversation may be stored to provide the learner with personalized content in the future. For example, if a mentor joins the platform 102 that would be a good fit for the learner based on a conversation with the chatbot, the platform 102 may notify or suggest the mentor to the learner. In addition, the chatbot may utilize metadata such as cookies to get further insights about the learner to gain a more complete picture on the learner (e.g., their likes, interests, etc.) and/or to provide more personalized recommendations and content as mentioned above.

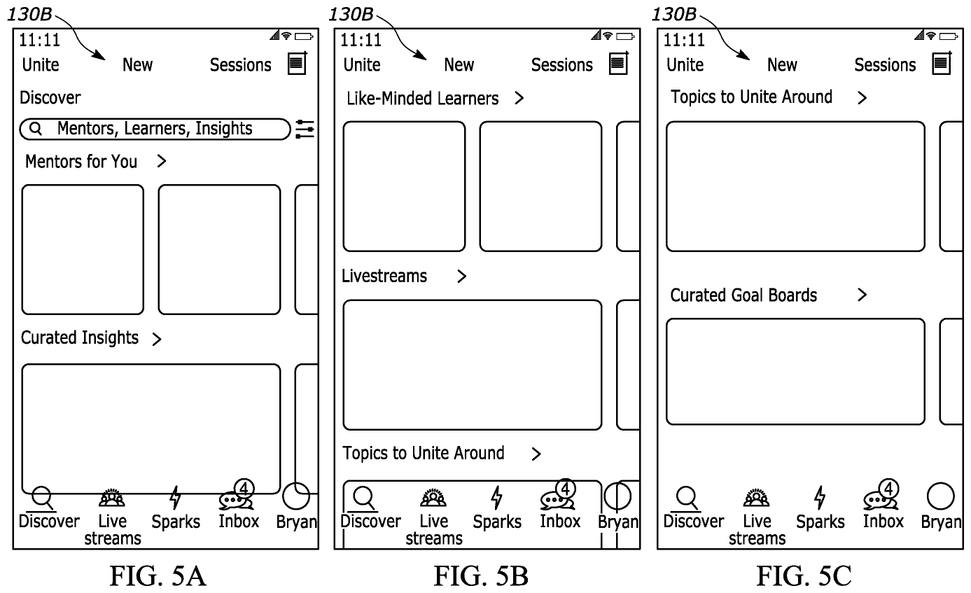

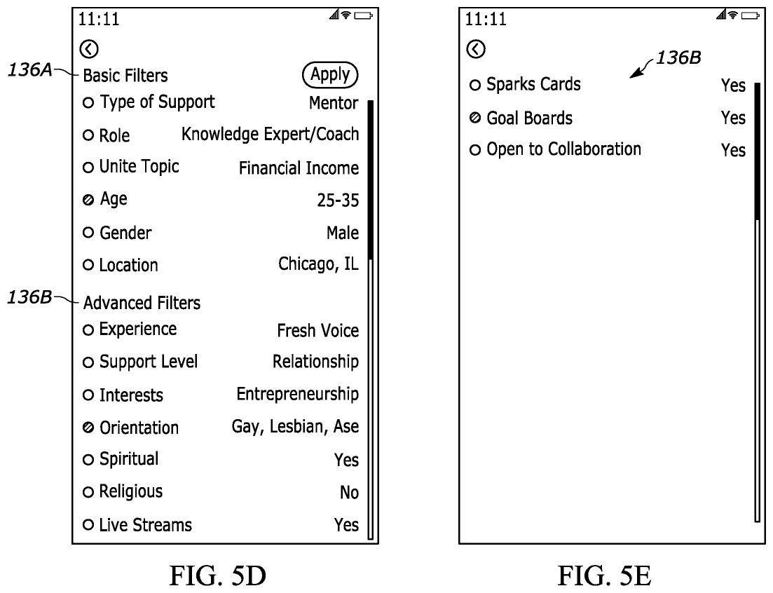

With respect to FIGS. 5A-E, the platform 102 may provide the learner with a discovery tool or tab 130B that the user may select. The discovery tool 130B may provide a search tool that a user may use to search for content and resources on the platform 102 (e.g., content relating to a certain topic), search of a mentor, curate insights, search for other learners, livestreams, topics to unite around, goal boards relating to a particular topic, etc. The user may scroll through the discover tool 130B to view various categories of content as shown in FIGS. 5A-C. The platform 102 may be configured to allow a user to select and apply filters 136 (see FIGS. 5D-E) to filter for content in the discovery page 130B. The platform 102 may be configured to only provide basic filters 136A for users who use the platform 102 for free and provide more advanced filters 136B for users who pay or have a premium subscription to the platform 102. The filter feature 136 that enables the user to search and narrow the content presented to a more focused subset, for example, the user may filter for livestreams or recorded seminars. Examples of search filters include, type of support offered by an instructor, user account role (instructor and/or learner), topic, age, gender, location, experience, support level, interests, sexual orientation, spiritual or religious, offered livestreams, spark cards, goal boards, and users that are open to collaboration. Learners and instructors can search for the right connection(s) by using the discovery tool and filtering through the results. When finding or offering support, users often seek to connect with the individuals and communities that can understand and best support them. With machine learning and predictive insights, the platform 102 begins to learn each user. This allows the platform 102 to aid the users in discovering, locating, and connecting with the instructors, learners, and/or learning that will impact and change their path in life.

Learners may select to subscribe to certain mentors or topics upon locating or coming across a mentor or topic they would like to continue seeing. A learner may be notified via their user device 124 when additional topic is added to the platform 102 relating to the learner's subscriptions. For instance, if a learner subscribes to a particular instructor or mentor, the learner may be alerted each time the mentor uploads new content (e.g., an insight or resource), schedules a learning session, or is scheduled to livestream. The new learning content of instructors a learner subscribes to may also appear on the learner's home screen 130A. A learner may be required to pay a subscription fee to subscribe to a mentor or to participate in one or more offerings (e.g., a class) on the platform 102. For example, for each mentor a user subscribes to, the learner may pay a monthly subscription fee to continue to access their content and receive support from the mentor.

Mentors may receive a percentage of the subscription fee paid by learners subscribing to them for their support. This provides an incentive and encourages mentors to seek to grow the number of learners subscribing to them or using their services on the platform 102. Mentors may encourage those they meet off the platform to join the platform 102 and subscribe to them, which in turn grows the number of users on the platform 102. Mentors may get paid monthly based on the revenue they bring in from learners for user of their services and from learner subscriptions. The mentors may get paid based on the number of learners that sign up for the mentors' services or subscribe to the mentor, which may be tracked when the learner's sign up through a trackable cookie on the learner's user device. A portion of the subscription/service fees paid by the learner's may go to the platform 102 for hosting the platform 102.

In this way, the system may be configured to offer affiliate recurring revenue payments which turns well-being and mental health into wellbeing-as-a-service that is delivered through a monthly subscription, allows learners to scale their support, and allows mentors to generate recurring revenue by bringing their clients onto the platform and getting paid monthly revenue for the services/subscriptions they sign up for through a trackable cookie on the end-user's device. By offering the recurring revenue structure discussed herein, the system creates a sustainable software as a service (“SaaS”) business model that brings wellbeing-as-a-service into fruition so that people can sign up and scale their support as they grow in their well-being and personal growth journey.

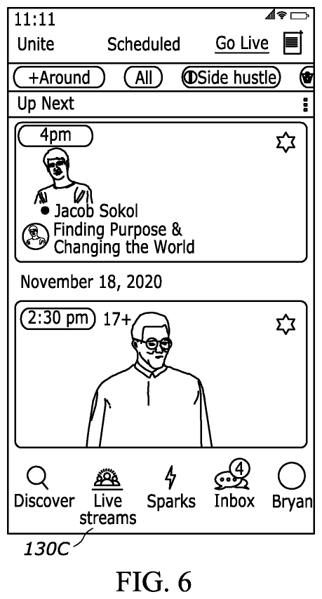

With reference to FIG. 6, the platform 102 further provides a livestream tab 130C where users are able to see what livestreams are occurring, scheduled, and trending. Livestreams enable instructors to offer high- level insights to create a conversation with the learners that are following an instructor. The user may be able to select to have the platform 102 notify or remind the learner of a livestream when the livestream is about to start. The livestreams displayed to the user may be based on the user's preferences and interests identified by the platform 102. The platform 102 may be configured to charge learners a fee for watching the livestream or subscribing to an instructor. In some forms, some livestreams are locked to those users of lower-tier subscription plans and can only be unlocked by enrolling in a higher-tier subscription plan. The platform 102 may allow the learner to watch or tune in to one or more livestreams or learning sessions hosted by a particular instructor to determine whether they would like to subscribe the instructor for support. This allows a learner to get a feel for a particular instructor before they subscribe to the mentor or pay for premium content offered by the platform 102. This serves to reduce the learner's uncertainty regarding whether a particular mentor is a good fit for them or will be able to support them based on whether their insights apply to their life. The platform 102 may allow instructors to offer free livestream sessions (e.g., 30-minute) to introduce themselves and the topics they cover for learners and instructors. The also allows instructors to show learners who they are and what they have to offer to grow their learner following. In some embodiments, the length of livestreams and the frequency with which an instructor can offer livestreams may be limited by the instructor's subscription plan. For example, non-paying instructors may be permitted to offer four 30-minute livestreams per month. Those mentors with high tier subscription plans may be able to offer more livestreams per month and for longer times if desired. At the end of the livestreams, instructors can offer upgrades to sell discounted Learning Sessions they are trying to fill for the week, offering up to 70% off for a drop-in session price compared to regular pricing. Instructors may also promote premium subscriptions which the platform 102 tracks and compensates instructors for (e.g., based on a percentage of the subscriptions they sell).

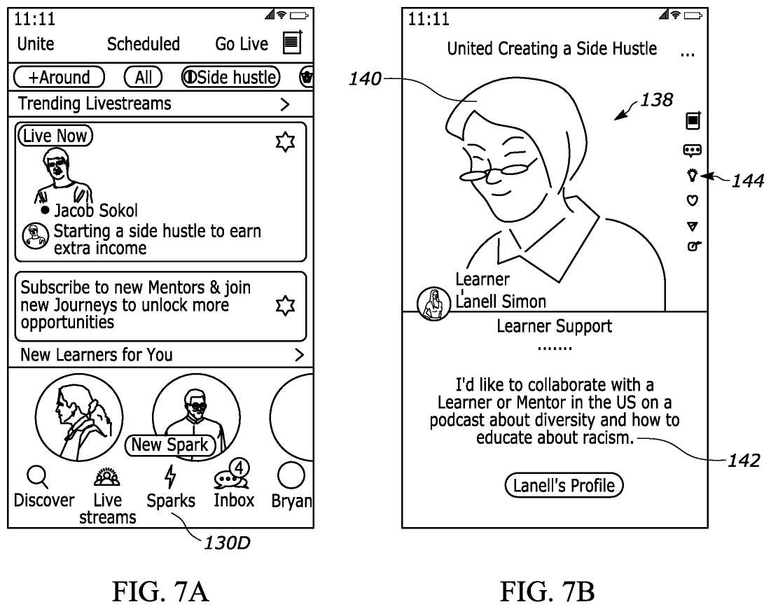

With reference to FIGS. 7A-B, the platform 102 further includes a spark tab or button 130D that allows users to create spark cards 138. Spark cards 138 allow instructors and learners to crowdsource support from the global platform 102 community. The goal of these spark cards 138 is to find the most spark around a common interest or ability to support one another. When two or more users have a common interest or ability to support one another, the users may connect which may turn into a dynamic relationship that may impact or change the user's life. In an age where social media has stripped away authentic human connection, the spark card 138 aims to build that authentic connection back up by allowing learners and instructors to see how they can offer and receive support from one another.

The spark card 138 may be a virtual card presented to other users on the platform 102 that is configured to allow learners to seek and offer support while allowing instructors to offer support and share the resources or content they have. In one embodiment, the upper part of the spark card shows a user uploaded image or video 140 with six support icons over the right of the image, while the bottom ⅓rd of the image is a data-generated carousel 142 that allows the community to learn about the user and how they can support this user. Other platform 102 users viewing the spark cards 138 of learners are able to see how they can support that learner, discover their basic info including their bio, and their goal boards. Users viewing spark cards 138 of mentors are able to see similar information including upcoming mentor livestreams, offerings, or available drop-in sessions. The spark cards may include support icons 144 that include icons allowing a user to add a mentor, learner, or insight to their goal board; comment on the spark card 138; share an insight to support that learner or mentor; introduce an instructor or learner; send a direct message to the user associate with the spark card 138; and share the spark card 138 with anyone on, or off, of the platform 102. When a spark card 138 is shared with someone off the platform 102, they may be required to create a user account to view the spark card 138 if they do not already have an account.

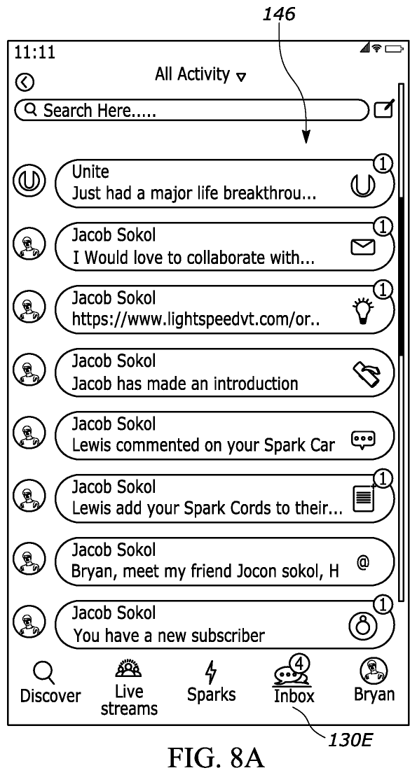

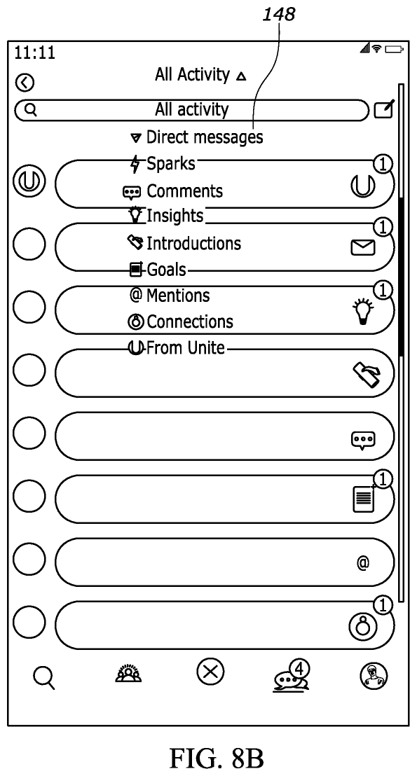

With respect to FIGS. 8A-B, the platform 102 may further include an inbox tab or page 130E. The inbox lists all of a user's notifications and messages 146 from other users. For example, a user may be notified when a livestream they indicated they were interested in is about to go live. As another example, an instructor may be able to view messages from the learners in the inbox. Notifications within the inbox all activity, direct messages, sparks, comments, insights, introductions, goals, mentions, connections, and messages from the platform 102. With respect to FIG. 8B, the inbox may allow users to break down their notifications within their inbox by type by selecting a filter 148. For instance, a user may select to view or filter for their direct messages, sparks, comments, insights, introductions, goals, mentions, connections, and messages from the platform 102. This allows learners and mentors to easily navigate and digest the support or interest they received while making decisions on how to tackle their life challenges. The inbox includes a messaging capability allowing a user to message and contact other users. Use of the inbox to notify users draws users back into the platform 102 multiple times per day to tend to their messages and notifications with other learners and instructors who are supporting them and helping them achieving their life goals. This creates an accountability system by drawing users back into the app, reminding them to stay true to their goals and what they need to focus on and accomplish to meet those goals.

Each user on the platform 102 may have a user profile 130F. The user profile 130F on the platform 102 consolidates all of an instructor's accolades into a single platform. Learner profiles may show information about who the learner is, which instructors or mentors they have discovered, their learner spark cards, and their goals boards. As a learner increases their subscribers and ratings aids to prove the information they are sharing is credible and in-demand, the platform 102 may suggest the learner create an instructor or mentor account and support other learners. The platform 102 thus identifies learners that may serve as a good instructor or mentor based on the learner's activity on the platform 102. The platform 102 may identify learner's that have a fresh voice, support them in building their voice on the platform 102, convert them to an instructor or mentor, and build their ability to support others and impact the world. The platform 102 thus helps build instructors and mentors into a dynamic instructors and mentor that create real change in a world that is in need of more leaders, visionaries, and healers. Some of the information of a user's user profile 130F may be public and viewable to other users, for example, whether the user is a learner or a mentor, what topics they are interested in, their goals, age, gender, etc. Other information associated with the user profile may be private and not viewable to other users, such as their login credentials, billing information, datasets generated by the user's activity on the platform 102, and any other information the user elects to keep private.

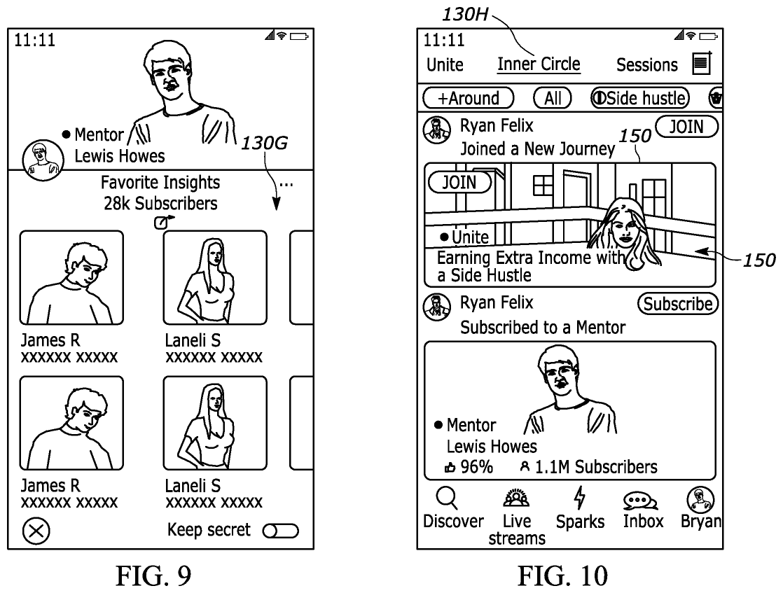

With respect to FIG. 9, the platform 102 may further include goal boards 130G. Goal boards 130G allow instructors and learners to create a page listing information the learner or instructor found helpful for others to view on their journey. For example, users can organize their favorite insights and resource links on a board that includes content from the user's instructors or mentors (on or off the platform 102) that helped them on their journey or were otherwise influential in their life. The goal boards 130G may include links for the user's favorite podcasts, YouTube videos, Ted Talks, Websites, Spark Cards, other user profiles on the platform 102, and other supportive resources and individuals. By creating goal boards 130G, every learner shares the resources (e.g., mentors, content) that have helped and supported them on their journey. Users may select to keep their goal board 130G private and as a way to organize resources for themselves. Users may also select to make their goal board 130G public for all to discover and view. When a user locates another user who struggled with a similar problem or accomplished a goal the user is seeking to accomplish, the user may search for the other user's goal board 130G to view the resources that the other user found helpful in their journey. Thus, as one user locates helpful resources as they work their way through a journey, they consolidate relevant, pertinent, and helpful resources on their goal board 130G, which others following on the same journey may use to help guide them on theirs, saving them time and reducing their struggle on their journey. When creating a new goal board 130G, the platform 102 may introduce a user to individuals and resources that may be helpful based on the topics of the user's goal board 130G they are creating and based on the user's signals that include in-session behavior, user data, and user characteristics. The platform 102 may suggest a user view another user's goal board 130G if the platform 102 determines the goal board 130G may include useful information to the user.

By creating goal boards, users on the platform 102 distill and consolidate information to a single board that other users may consult on their own journeys. Currently, the internet is full of helpful resources, but individuals often struggle to locate and determine what content is actually credible, helpful, and share worthy.

With respect to FIG. 10, the platform 102 may also include an inner circle page 130H. A learner's inner circle includes a newsfeed 150 of what a user's connections, or friends, and subscribers are doing on the platform 102. For example, a learner may see a user profile of an instructor their connections have subscribed to, content they have shared or commented on, connections they have made, etc. The inner circle page 130H may server to provide a user with content that they may find of interest, being of interest to their connections or friends on the platform 102. For example, when a learner discovers a friend or subscriber is watching a livestream or is joining a journey, the learner may be influenced by their friend or subscriber and also join the livestream or join the journey. By allowing a user to see what their connections and friends are doing on the platform 102, the user is able to experience the platform 102 with their friends and in groups. Being influenced by what others are doing on the platform 102, a user may be empowered to take action in achieving a goal in their life, make connections, learn about a topic, and use the features of the platform 102. Especially as we age, it becomes increasingly difficult to build social bonds and support systems, thus, the inner circle feature 130H serves to bond users around their humanness and struggles while sharing and discovering what others are doing on the platform.

The platform 102 may be configured to hold users accountable to their goals. For example, users may be able to select a journey and set goals for themselves to have accomplished at various point in time. The platform 102 may provide the user with notifications, alerts, and reminders to keep the user on track to meet their goals. The platform 102 may further include challenges that a user may complete (e.g., each month) to keep a user in action as they work toward achieving a goal.

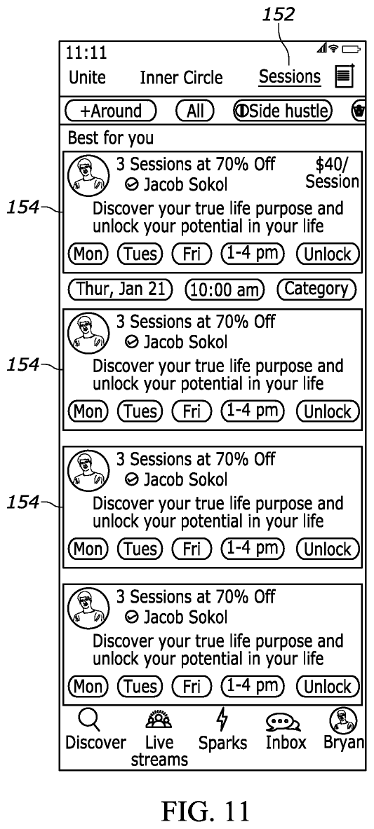

With respect to FIG. 11, the platform 102 may include a sessions tab 152 which users may select to view, browse, and join learning sessions offered by instructors on the platform 102. The sessions tab 152 may provide a list of sessions 154 the platform 102 determines may be a good fit for the user based on their interests and preferences determined from their user profile and monitored activity and the content of the learning session. The user may select to join or purchase the sessions displayed. As shown, the sessions displayed in the sessions tab 152 may be sessions offered at a discount by an instructor. For instance, if an instructor currently has low demand and is looking to have more learners to join their sessions, they may offer their sessions at a discount rate to learners to encourage learners to sign up or join the class, workshop, seminar, or other learning session they are offering.

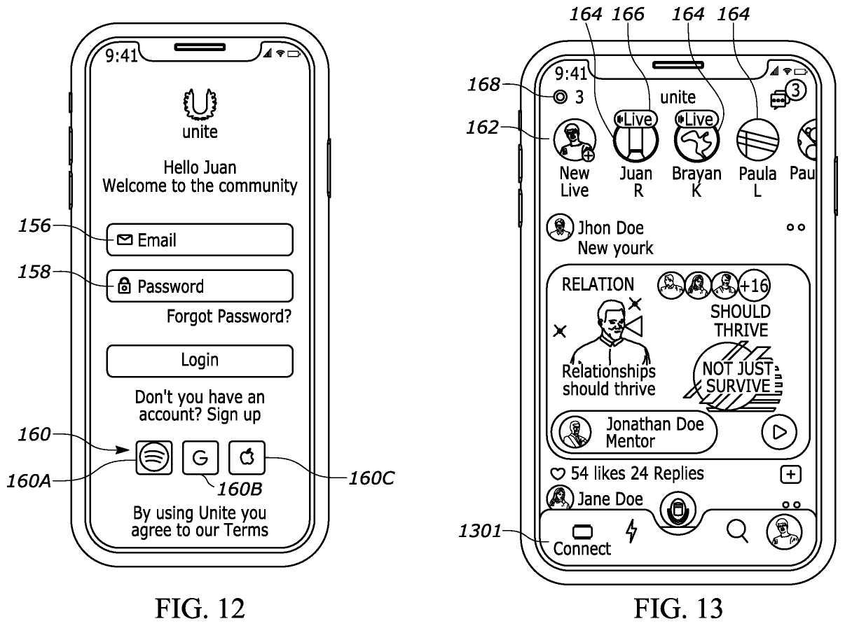

With respect to FIG. 12, the platform 102 may include a log-in screen where a user may enter an email address/username 156 and associated password 158 to access their existing user account. The user may also signup for the platform 102 by, for example, entering an email address and password. In some forms, the platform 102 may be configured to permit a user to sign-up for the platform 102 or create a user account by using or linking their user accounts with another service or platform 160. For example, a user may create an account using their user account associated with Spotify 160A, Google 160B, Apple 160C, Facebook, Twitter, TikTok, and/or other such platforms. The user may select their account associated with the other service or platform 160 and link it with the social learning platform 102 to link the accounts. The social learning platform 102 may receive the user's personal information (e.g., name, address, date of birth, etc.) from the linked user account so that the user doesn't have to type or enter this information in manually. The social learning platform 102 may also receive other information collected by the linked user account such as the user's content preferences and content interaction history from the platform 160 of the linked user account. For instance, if the user links their Spotify account with the social learning platform 102, the social learning platform 102 may receive information pertaining to the user's interests collected by Spotify, such as music and/or podcast listening history or preferences. As another example, if the user links their Twitter account, the social learning platform 102 may receive a list the user accounts that the user follows or data indicating the content the user interacts with.

With respect to FIG. 13, the social media platform 102 may include a graphical user interface with a connect tab 1301. Upon selecting the connect tab 1301, the social media platform 102 may present a page providing the user with various mentors, insights, and learners for the user to interact with and/or connect with. The connect tab 1301 serves to introduce the user to new mentors, learners, and content that the social learning platform 102 determines may be of interest to the user based on the user's profile and platform usage history. For example, social learning platform 102 may present mentors, learners, and content to the user in the connect tab 1301 based on the mentors and learners the user is currently following. As another example, the social learning platform 102 may present mentors, learners, and content to the user in the connect tab 1301 based on the content the user has listened to, shared, commented on, clicked on, read, or otherwise interacted with. In some forms, the connect tab 1301 may be used in place of the inner circle tab 130H, however, in other forms the social media platform 102 may include both the connect tab 1301 and the inner circle tab 130H.

As shown, the social media platform 102 may include a carousel 162 of conversation icons 164 for user conversations and live conversations that a user may select to listen to and/or interact with. For example, the user may scroll through the carousel 162 by clicking and dragging the carousel 162 to the left or the right to reveal additional conversation icons 164 the user may select to listen to or engage with. The conversation icons 164 that are presented to a user on their connect tab 1301 may be conversations and/or content shared by mentors or learners the user is connected with or following. The user may select (e.g., click or touch) the icon 164 on the screen to begin listening to or viewing the content associated with the conversation icon 164. The content associated with the conversation icons may be, as examples, a live video stream, a recorded video, a live audio stream, a recorded audio stream, a picture, presentation or the like. In some forms, where the content of the conversation icon 164 is live content, a live content icon 166 may be presented with the conversation icon 164 indicating the content is live to the user.

The social media platform 102 may also reward a user with coins or tokens 168 of the social learning platform 102 to encourage users to interact with and engage content. For example, a user may receive tokens 168 for watching, listening, or attending a stream, podcast, video, webinar, training session or the like. A user may also receive tokens 168 for reading an article or a transcription of a podcast, webinar, etc. A user may also receive tokens 168 for commenting on such content, sharing content, contributing to live conversations about a topic, and creating or posting content. The tokens may be used to unlock additional content within the social media platform. For example, the user may exchange tokens to access premium content, to attend a training session with a mentor, meet with a celebrity mentor, etc. The social media platform 102 present the user with the number of coins or tokens 168 the user has earned on the connect tab 1301.

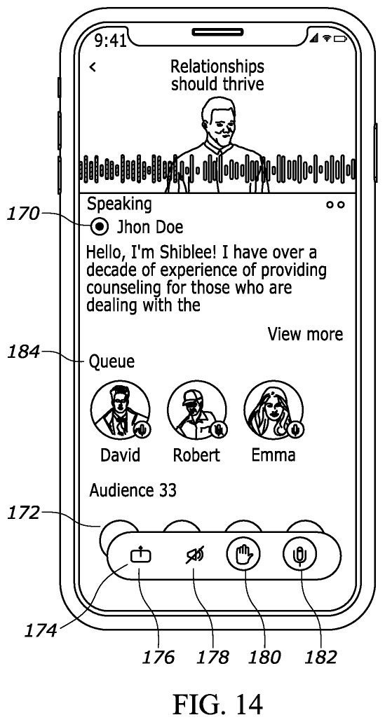

With respect to FIG. 14, the social media platform 102 may include live conversations that a user may join to discuss a particular issue or topic with other users. A user may start, host, moderate or facilitate the conversation about a particular topic as a live conversation that other users are able to view an icon within the social media platform 102 (e.g., via a conversation icon 164) to select to join. When in a live conversation, a user is able to view the user 170 that is speaking and a list of the other user(s) 172 that may have joined the conversation. Each user is presented with a control panel 174 with various icons for use during the live conversation. In the form shown, the control panel 174 includes a share button 176, a speaker button 178, a raise hand button 180, and a mute button 182. The share button 176 allows a user to share the live conversation or a portion of the live conversation to other social media platforms or within the social media platform 102 for others to view. The share button 176 may permit a user to select a clip or segment of the live conversation to share (e.g., a two minute segment or a quote from a user within the conversation) or the entire live conversation. The user may also be able to share the link to the live conversation so that others may select the link and join the live conversation to listen in on and/or participate in the conversation. The speaker button 178 may permit a user to toggle the audio on and off to permit or stop the audio from being played to the user. The raise hand button 180 permits a user to be added to a queue 184 of users who wish to speak or contribute to the conversation. Upon selecting the raise hand button 180, the user is added to the queue 184 of user's who would like to speak to, for example, offer advice, comment, or pose questions relating to the topic being discussed. By providing a queue 184, the conversation is conducted in an orderly fashion so that users are not speaking through one another. After a user has completed speaking, the next user of the queue may be unmuted and permitted to speak. In some forms, the user that started the live conversation may be the moderator that is able to select when the next user in the queue may be unmuted to begin speaking and to advance and control the live conversation. A user may use the mute button 182 to toggle their microphone on and off. When the user's microphone is toggled on, the user's audio is transmitted to the social media platform 102 and may be presented to the other users that have joined the conversation.

The live conversation may be recorded for others to view, listen to, and interact with after the live conversation has ended. A user may then share the conversation with others to keep the conversation going among other users. Users may share the conversation or a portion thereof as a spark card to share an insight and/or allow others to continue to converse and comment on the conversation. The live conversation may be broken into smaller segments that a user may share to provide smaller, shorter “bite” sized micro-content for others to learn from, listen to, and engage with. For example, the live conversation may be divided into segments associated with each person that spoke during the live conversation. A user may then share that user's comment, advice or insight separate from the rest of the live conversation so that others may engage with the smaller segment of the conversation rather than having to listen to the entire conversation from the start to the finish to hear an important insight. By allowing shorter portions of these conversations and other content to be shared apart from the entire length of a content, the important aspects of the content may be made available to others without the need to sift through the content or listen to the entire length of the conversation, stream, etc. A challenge with existing live format content is that once the live session is over, the content is gone. Another challenge is that many podcasts, live conversations, or videos include multiple nuggets of wisdom or advice hidden throughout a longer event (e.g., an hour). Users often do not have the time to listen to the full-length content but desire to hear these nuggets of wisdom or advice provided in the content. The social learning platform 102 permits users to extract shorter clips or segments (e.g., two to five minutes) of the full-length content and share these clips as micro-content with others so that others may view and have more ready access to these smaller portions or shareable bites of information.

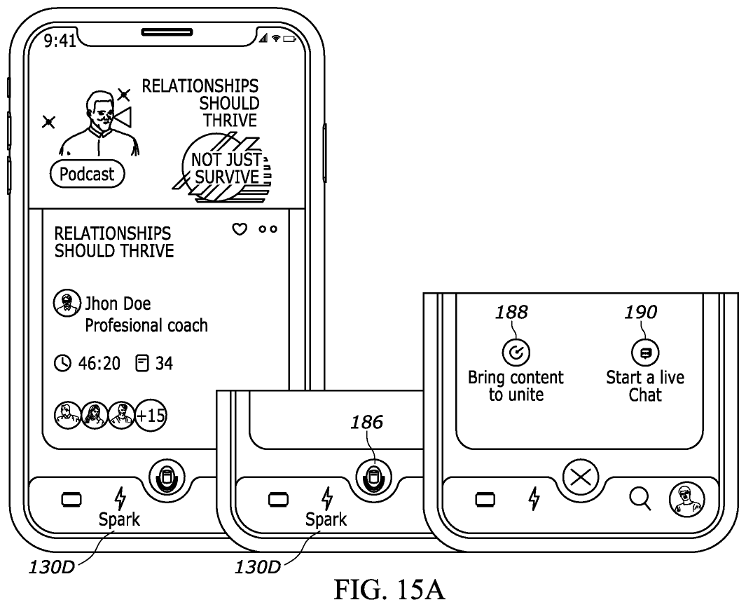

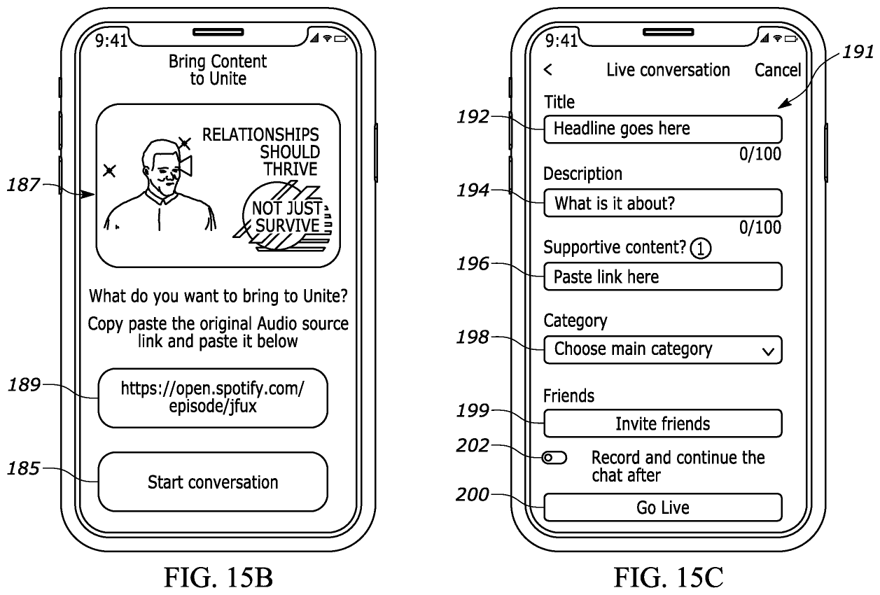

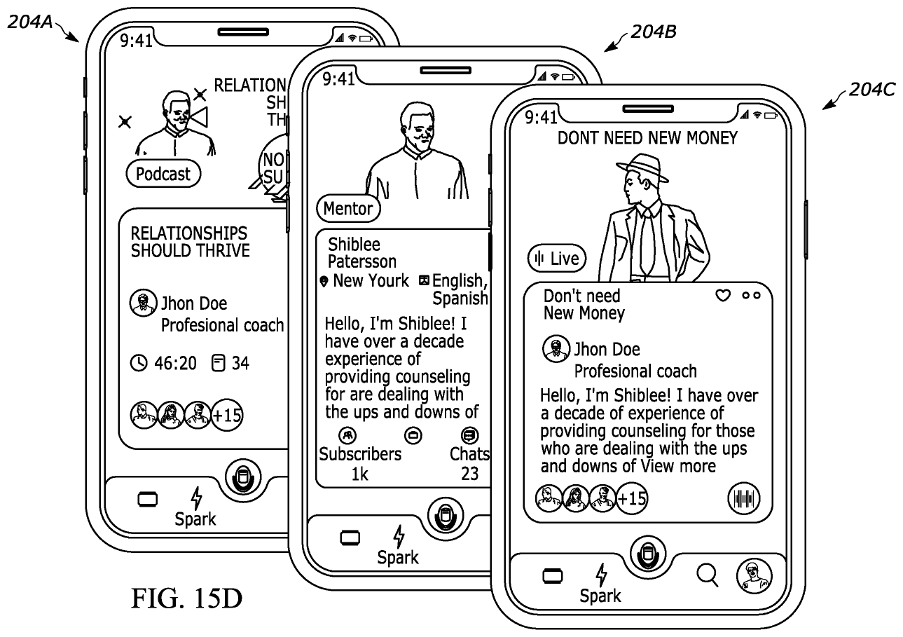

With respect to FIGS. 15A-15D, a user may spark conversation via the spark tab 130D. With respect to FIG. 15A, a series of graphical user interface screens (or portions thereof) are shown demonstrating that the spark tab 130D may permit a user to bring content into the social learning platform 102 from other platforms (e.g., Facebook, Twitter, etc.) to share with other users and or start a live conversation or chat about a content or a topic. For example, the user may select the spark tab 130D on the user interface and then select the microphone icon 186 to create a new spark. Upon selecting the microphone icon 186, the user may be presented with a button 188 to bring content into the social learning platform 102 and a button 190 to start a live chat.

The user may select the button 188 to import or share content from another platform or source into the social learning platform 102 to share with others on the social learning platform 102. For example, a user may import an article, post, comment, podcast, video, image, etc. from another social media platform into the social learning platform 102. For example, a user may import such content from Facebook, Twitter, Instagram, Snapchat, Spotify, Google, or any other news or information source providing content that may be of interest. With respect to FIG. 15B, an example graphical user interface 187 is shown that may be presented to the user upon selecting button 188. An input box 189 may be presented to the user into which the user may type or paste a link to the content they would like to share with others in the social learning platform 102. The user may select the button 185 start a conversation about the linked content. As one example, upon selecting the button 185 a spark card may be created that other users may view and interact with. For instance, other users may share the spark card or link, comment on the spark cards, and/or start live conversations to discuss the linked content. In some forms, the user may start a live conversation, such as that described above, around the imported content to spark conversation relating to the linked content, discuss the user's thoughts, comments, advice or the like around the linked content, and/or to hear other thoughts, comments, advice or the like relating the same.

With reference again to FIG. 15A, the user may select the button 190 to start a live chat or live conversation such as that described above. In one form, a learner may start a live conversation about content the user has questions about, struggles with, is looking for advice on, and/or wants to discuss with others or hear other's thoughts or opinions on. A mentor or other users knowledgeable on the topic may join the conversation to provide their insight and thoughts. Other users may join the live conversation that are interested in the topic and may either listen to hear what others have to say relating to the topic or may actively participate (e.g., as described above by raising their hand and joining the queue 184). Upon selecting the button 190 to start the live chat, the user may be presented with a graphical user interface 191 such as that shown in FIG. 15C to provide details regarding the conversation they would like to start. The user may be prompted to provide a title or headline 192, a description 194 of what the conversation is about, supportive content 196, and a category 198 that the conversation relates to. The supportive content 196 may be a link to an article, podcast, post, image etc. that other users may reference or that relates to the conversation the user would like to have a conversation about.

The user may also select a button 199 to invite friends to join their live conversation. Upon selecting friends to join the live conversation, the user's selected friends may be alerted that the user has invited them to join their live conversation. The alert may provide the friends with details pertaining to what the live conversation will be about, such as the headline 192, description 194, supportive content 196, and/or category 198 entered by the user. The friends may receive a push notification prompting them to join the live conversation or that the user has started the live conversation. As other examples, the user may receive an alert or notification within the social learning platform 102, a message to their inbox, an email, or text.

The user may select the “Go Live” button 200 to start the conversation and begin hosting a live session in which users may chat and discuss the selected topic with the user. In some forms, the live conversation may take place via audio. In some forms, one or more user's may be able to share a picture, presentation, video, article with others who join the conversation (e.g., shared screen). In some forms, the live conversation may take place via audio and video. For example, participating users may turn on a webcam so that others may see them or so that they may show others things visually.

The graphical user interface 191 may include a toggle switch 202 that a user may use to select whether to record the live conversation so that others may view the recorded conversation after the live stream has ended. This may allow others to continue to discuss the topic by, for example, commenting on the recorded conversation and sharing segments of the discussion. For instance, a user may then start a live conversation about a segment of the discussion, e.g., to discuss a comment made by one of the speakers.

With respect to FIG. 15D, examples of spark cards are shown that are created and shared as described above. The example spark cards shown include a podcast spark card 204A, a mentor spark card 204B, and a live conversation spark card 204C. A user may view these spark cards in the social learning platform 102. For example, the social learning platform 102 may present a spark card to a user upon determining the spark card may be of interest to the user. As another example, the spark card may be listed in the user's homepage or presented to the user when in the discover tab 130B. User's may also share or send spark cards with others on the social learning platform 102 encouraging them to view, join, and interact with the spark card and the related content. Spark cards may also be sent to those who do not yet have a user account on the social learning platform 102. A user may send the spark card to a phone number or email address associated with the intended recipient. The social learning platform 102 may provide the recipient with a link to download the social learning platform 102 and/or to create a user account to join the social learning platform 102.

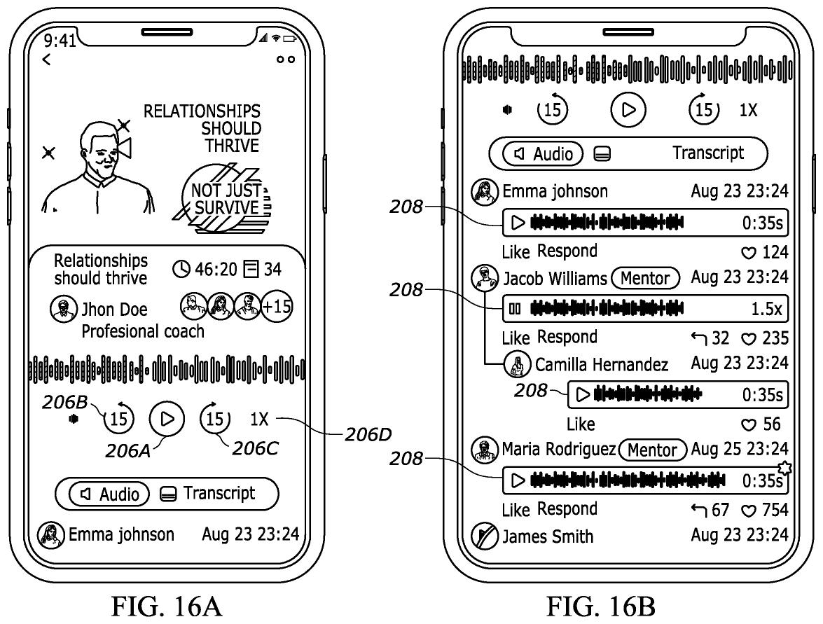

With respect to FIG. 16A-B, an example interface is shown for how users may interact with content (such as a live conversation, training session, podcast, etc.). In the example shown, the user is listening to a podcast entitled “Relationships Should Thrive.” The social learning platform 102 may provide the user with control functions for listening to a podcast, video or a clip from the podcast or video (e.g., in a spark card). As shown, the social learning platform 102 may include a play button 206A to play/stop listening to the podcast, rewind button 206B to rewind several seconds (e.g., 15 seconds), fast-forward button 206C to skip forward several seconds (e.g., 15 seconds), and/or a button 206D to adjust the speed at which the podcast is played to the user. The user may scroll downward to view the interface of FIG. 16B and to view comments 208 posted by other users. In the form shown, the comments are audio clips posted by users that the user may select to listen to. Users may leave their own comments responsive to the podcast (or clip of the podcast) and/or respond to other's comments to have a conversation and/or share insights with others commenting and interacting with the content. The users may also like or share the comments left by other users. In some forms, the user may create a spark card or start a live conversation based on the podcast and/or a comment left by a user. While the comments shown are audio clips, in some forms textual and/or audiovisual comments may be used in place of or in addition to the audio comments.

The social learning platform 102 may share comments with other platforms (e.g., Spotify, Facebook, Youtube, etc.) where users are interacting with the same content across the platforms. In other words, the social learning platform 102 may import comments left by users on other platforms so that those comments are viewable by users on the social learning platform 102 when users view that same content. The social learning platform 102 may likewise export comments left by users in the social learning platform 102 to other platforms so that comments left by users in the social learning platform 102 are viewable by users of the other platform that are viewing the same content. For instance, where a user is listening to a podcast on Spotify and leaves a comment, that comment may be imported into the social learning platform 102 so that users listening to the same podcast on the social learning platform 102 see the comment and can interact with the comment to keep the conversation going across all platforms that the content is on. For example, where a user leaves a comment at the 2:24 minute mark of the podcast via Spotify, that same comment may be displayed at the 2:24 minute mark to users listening to the podcast on the social learning platform 102. The social learning platform 102 may likewise export comments left by users interacting with the podcast content in the social learning platform 102 so that users viewing the same podcast on other platforms (e.g., Spotify, Facebook, Youtube, etc.) are able to see the comments left by a user in the social learning platform 102. Users are thus able to view, interact, with and respond to other users of different platforms since comments and comment threads are shared across the various platforms that the content (e.g., podcast, video, graphic, etc.) is hosted on. The sharing of comments and other interactions (e.g., reactions) across platforms may be accomplished using an RSS feed. Once a user leaves a comment or reaction on content in the social learning platform 102, that comment or reaction may propagate to other platforms hosting the same content via the RSS feed and vice versa. The RSS feed may share the comments across the platforms in real-time or near real-time. Thus, two users are able to have a conversation, collaborate, and/or interact with one another even if they are using different platforms to view, listen to, and/or interact with content.

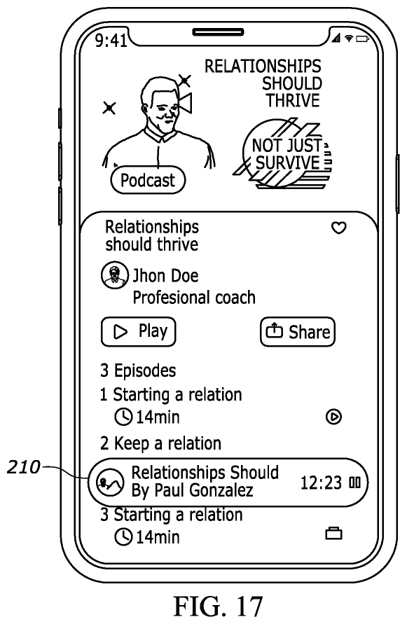

With respect to FIG. 17, the audio control panel 210 is shown in a collapsed configuration. The user may select the play button to listen to audio content and continue navigating or exploring other pages and content on the social learning platform 102 while the audio content plays. The audio control panel 210 may collapse to a smaller form, such as that shown in FIG. 17, to provide the user with a control panel 210 that the user may use to stop the audio playback of the audio content they are listening to. The user may also tap or double tap the control panel 210 to return to the audio content and/or to expand the control panel 210 to include other control features such as rewinding, fast-forwarding, adjusting the playback speed, etc.

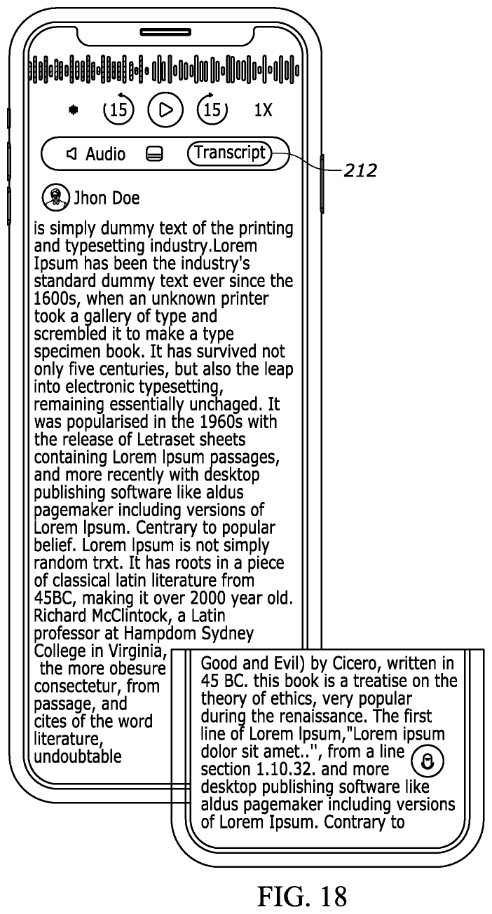

With respect to FIG. 18, the social learning platform 102 may provide an audio/transcript button 212 that the user may use to select whether to listen to the audio content (e.g., podcast, live conversation, audio comment) or read a transcription of the audio content. In some forms, the user may view the transcription and listen to the audio playback to aid the user in listening and understanding the audio content. The social learning platform 102 may include voice processing algorithms for processing the audio component of the content and generating a textual transcription of the audio content. Upon request of a user, the social learning platform 102 may present the transcription to the user. The social learning platform 102 may also use the transcription of the audio content for keyword searching by users in the discover mode, to determine the type of content based on the keywords of the transcription, and to present the audio content to users upon determining the audio content is of interest to the user based on the transcription.

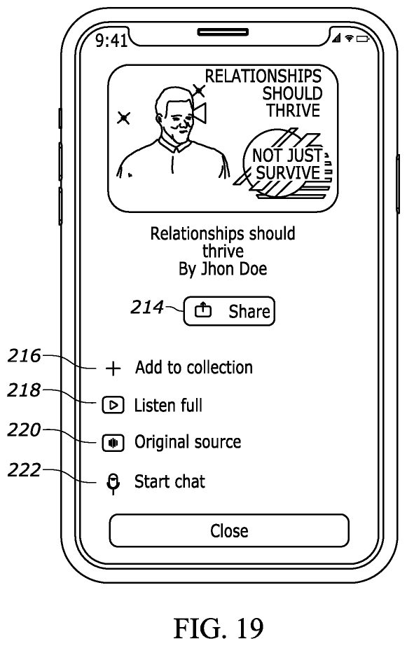

With respect to FIG. 19, the social learning platform 102 may provide the user with several options for interacting with content. As shown, the user may select to share the content by selecting the share button 214. The user may select the add to collection button 216 to add the content to a folder or to save the content for later reference. The user may select the listen full button 218 to listen to the full length of the content. For instance, where the user has listened to a clip or excerpt from a larger audio/audiovisual work, the user may select to listen to or navigate to the full-length version, for example, to listen to the entire conversation, presentation, or discussion. The user may select the original source 220 button to view or open a link to the original source from which the content was found. For example, if the original source for a podcast was on Spotify, the social learning platform 102 may provide this information to the user, may provide the user with a selectable link to navigate to the original source, and/or may launch the link to open the original source for the user. The user may select the start chat button 222 to start a conversation (e.g., create a spark card and/or live chat) about the content.

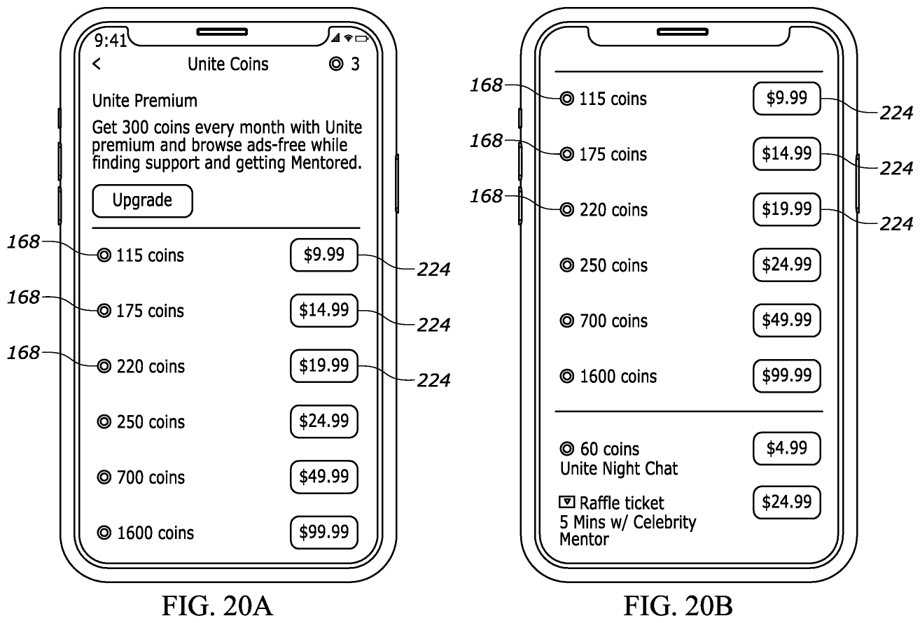

With respect to FIG. 20A-20B, the social learning platform 102 may allow users to purchase coins or tokens 168 using cash. As shown, the social learning platform 102 provides the users with various buttons 224 for purchasing varying numbers of tokens 168 for use in unlocking features and content within the social learning platform 102 as described above. The social learning platform 102 may also provide the users with a button 226 a user may select to enter a raffle to have a conversation with or meet a celebrity mentor. While the above discusses the use of coins or tokens, it should be understood that any form of non-fungible token (NFT) may be utilized as desired. In addition, while the above discusses how comments may be taken live in the social learning platform 102 discussed herein, it should be understood that this concept may be utilized in any social media platform beyond the social learning platform 102. For example, this concept may be implemented in other platforms such as Facebook, Twitter, YouTube, Instagram, Spotify, etc., and such is intended to be covered by this disclosure.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Various embodiments described may be implemented primarily in hardware, or software, or a combination of hardware and software. For example, a hardware implementation may include using, for example, components such as application specific integrated circuits (“ASICs”), or field programmable gate arrays (“FPGAs”). Implementation of a hardware state machine capable of performing the functions described herein will also be apparent to those skilled in the relevant art.

Given that the disclosure herein may be to physical hardware or software, the terms herein should not be limited to a software or hardware component, such as an FPGA or an ASIC, which performs certain tasks. For example, an item discussed herein may advantageously be configured to reside on an addressable storage medium and configured to execute on one or more network enabled devices or processors, such as a module. Thus, a module may include, by way of example, components, processes, functions, attributes, procedures, subroutines, segments of program code, drivers, firmware, microcode, circuitry, data, databases, data structures, tables, arrays, variables, and the like. The functionality provided for in the components and modules may be combined into fewer components and modules or further separated into additional components and modules. Additionally, the components and modules may advantageously be implemented to execute on one or more network enabled devices or computers.

Furthermore, those of skill in the art will appreciate that the various illustrative logical blocks, modules, circuits, and method steps described in connection with the above-described figures and the embodiments disclosed herein can often be implemented as electronic hardware, computer software, or combinations of both, for example, on a personal user device such as a personal computer, virtual machine, smart speaker, and/or mobile device (e.g., smartphone, tablet computer, laptop, wearable smart device, etc.). To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Further, they may be rolled out in downloadable or non-downloadable features (e.g., application software for download from an software application store, non-downloadable software accessible via a portal interfaces such as a website, etc.). Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC. By way of example, in some embodiments a storage medium may store a computer program executable by a processor based system. The computer program may be configured to cause the processor based system to execute steps comprising any of the methods and/or techniques described herein.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. Thus, the invention is not intended to be limited to the embodiment shown herein but is to be accorded the widest scope consistent with the principal and novel features disclosed herein.

Still further, while there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. An interactive social learning environment system comprising:
a processor-based platform accessible via a user device via a network, the platform configured to:
receive personal information and one or more topics of interest associated with a user;
receive a selection from the user to create at least one of an instructor user profile or a learner user profile;
receive learning content from one or more instructors;
determine via predictive analytics, at least a subset of learning content to provide to the user based at least in part on the personal information and one or more topics of interest; and
present the at least a subset of learning content to the user via a user device associated with the user.

2. The system of claim 1 wherein the learning content includes at least one of a livestream seminar, recorded seminar, workshop, a group discussion, one-on-one discussion, mentoring session, training program, and self-directed learning materials.

3. The system of claim 1 wherein the user is able to selectively engage with learning content, wherein the platform is further configured to:
monitor the engagement of a user with learning content, where determining at least a subset of learning content to provide to the user is further based at least in part on the engagement of the user with learning content.

4. The system of claim 3 wherein monitoring includes at least one of tracking the type of content the user engages with, tracking the time the users engage with learning content, and tracking the topic of the learning content the user engages with.

5. The system of claim 1 wherein receiving personal information and one or more topics of interest includes receiving input to a series of questions presented to the user via the user device.

6. The system of claim 1 wherein the platform is further configured to:
create, via input from the user via the user device, a spark card including visual and/or audio content and information relating to supporting the user, the spark card enabling other users of the platform to search for, view, and interact with the spark card to support of the user.

7. The system of claim 1 wherein the platform is further configured to:
create, via input from the user via the user device, a goal board including a goal and one or more resources associated with the achieving the goal, the goal board being able to be presented to another user of the platform to aid the another user in achieving the goal.

8. An interactive social learning environment system comprising:
a processor-based platform accessible via a user device via a network, the platform configured to:
receive personal information and one or more topics of interest from a user via a user device;
present information to the user via the user device a homepage including at least one of a suggested user to connect with, an insight, a topic to explore, a journey to take, a goal to achieve, an instructor offering, and a suggested learning session based at least in part on the personal information, one or more topics of interest, and activity of the user on the platform;
receive a selection from the user to join a journey program of the platform and present curated content to the user via the homepage based at least in part on the selected journey program;
present a discovery tool to the user via the user device and receive a search from the user via the discovery tool for at least one of another user, a community, an insight, and learning content;
create, via input from the user via the user device, a spark card including photographic content and information relating to supporting the user, the spark card enabling other users of the platform to search for, view, and interact with the spark card to support of the user;
create, via input from the user via the user device, a goal board including a goal and one or more resources associated with the achieving the goal, the goal board being able to be presented to another user of the platform to aid the another user in achieving the goal; and
presenting to the user an inner circle newsfeed of one or more actions of one or more users that the user is connected with.

9. The system of claim 8 wherein the platform is further configured to:
receive learning content from one or more instructors; and
present the at least a subset of learning content to the user via a user device associated with the user.

10. The system of claim 9 wherein the platform is further configured to:
receive an indication from the user to subscribe to the learning content of an instructor.

11. The system of claim 10 wherein the learning content includes at least one of a livestream seminar, recorded seminar, workshop, a group discussion, one-on-one discussion, mentoring session, training program, and self-directed learning materials.

12. The system of claim 8 wherein the platform is further configured to:
monitor the engagement of a user with learning content, where at least a subset of the information presented to the user via the homepage is based at least in part on the engagement of the user with learning content.

13. The system of claim 12 wherein monitoring includes at least one of tracking the type of content the user engages with, tracking the time the users engage with learning content, and tracking the topic of the learning content the user engages with.

14. The system of claim 8 further comprising:
a first user device associated with the user;
a second user device associated with an instructor of the one or more instructors.

15. A device for facilitating interactive learning, the device comprising:
a memory;
communication circuitry configured to communicate via a network;
a user interface;
a processor communicatively coupled to the memory, the communication circuitry, and the user interface, the processor configured to:
receive personal information of a user via the user interface;
receive input indicating a topic of interest via the user interface;
receive input selecting at least one of a mentor user profile and a learner user profile;
communicate, via the communication circuitry, the personal information and the topic of interest of the user to a remote computing device;
receive from the remote computing device, via the communication circuitry, one or more learning content programs to present to the user via the user interface, the one or more learning content programs selected from a plurality of learning content programs using predictive analytics based at least in part on the personal information and topic of interest; and
presenting, via the user interface, the one or more learning content programs to the user.

16. The device of claim 15 wherein the learning content programs include at least one of a livestream seminar, recorded seminar, workshop, a group discussion, one-on-one discussion, mentoring session, training program, and self-directed learning materials.

17. The device of claim 15 wherein the user is able to selectively engage with learning content via the user interface, wherein the processor is further configured to:
monitor the engagement of a user with learning content; and
communicate, via the communication circuitry, data associated with the engagement of the user with the learning content to the remote computing device, wherein the one or more learning content programs are selected based at least in part on the engagement data of the user.

18. The device of claim 17 wherein monitoring includes at least one of tracking the type of content the user engages with, tracking the time the users engage with learning content, and tracking the topic of the learning content the user engages with.

19. The device of claim 15 wherein the processor is further configured to:
receive an indication from the user via the user interface to subscribe to a mentor; and
communicate the indication to subscribe to the mentor to a remote computing device.

20. The device of claim 15 wherein presenting includes at least one of displaying the learning content programs to the user via a display screen of the user interface and notifying a user of the one or more learning content programs via a push notification.
